(19) United States
(12) Patent Application Publication
(10) Pub. No.: US 2026/0214081 A1
(43) Pub. Date: Jul. 23, 2026

(54) SYSTEMS AND METHODS FOR SECURELY REUSING A DIGITAL PROFILE FOR A USER EQUIPMENT

(71) Applicant: Verizon Patent and Licensing Inc., Basking Ridge, NJ (US)

(72) Inventors: Manuel Enrique CACERES, Basking Ridge, NJ (US); Axel HALLO DE WOLF, Whippany, NJ (US); Alexandre DE MELO, Murrieta, CA (US); Qi LU, Round Rock, TX (US); John M. STOKES, Yorba Linda, CA (US)

(73) Assignee: Verizon Patent and Licensing Inc., Basking Ridge, NJ (US)

(21) Appl. No.: 19/030,419

(22) Filed: Jan. 17, 2025

(51) Int. Cl. H04L 9/40

(52) U.S. Cl. CPC H04L 63/0442

(57) ABSTRACT

A device may receive a request to transfer a digital profile from a first electronic subscriber identity module (eSIM) to a second eSIM, where the digital profile includes multiple seeds used to generate new network authentication keys. The device may generate, based on one of the multiple seeds, the new network authentication keys for the digital profile, and may replace existing network authentication keys of the digital profile with the new network authentication keys. The device may communicate the new network authentication keys to a mobile network operator backend system, and may enable the digital profile with the new network authentication keys on the second eSIM. The device may prevent reuse of the digital profile on the first eSIM.

### BACKGROUND

The telecommunications industry may provide security and manageability of subscriber identity modules (SIMs). Traditionally, physical SIM cards have been used to store subscriber information, which may be physically transferred from one device (e.g., a user equipment UE) to another UE.

### BRIEF DESCRIPTION OF THE DRAWINGS

FIGS. 1A-1F are diagrams of an example associated with securely reusing a digital profile for a user equipment.

FIG. 2 is a diagram of an example environment in which systems and/or methods described herein may be implemented.

FIG. 3 is a diagram of example components of one or more devices of FIG. 2.

FIG. 4 is a flowchart of an example process for securely reusing a digital profile for a user equipment.

### DETAILED DESCRIPTION OF EXAMPLE EMBODIMENTS

The following detailed description of example implementations refers to the accompanying drawings. The same reference numbers in different drawings may identify the same or similar elements.

Transferring subscriber information poses a challenge when dealing with embedded SIMs (eSIMs), which are soldered into devices and not meant to be removed. The provisioning of eSIM profiles and the secure transfer of ownership or service between devices, while maintaining privacy and preventing the duplication or cloning of eSIM profiles, present concerns. Additionally, an ability for an enterprise to manage large volumes of eSIMs, including the buying and selling of eSIM assets between entities, further complicates the situation. These issues are compounded by the need to comply with security policies that prohibit the downloading of the same eSIM profile to multiple devices, as well as provision of a method that mimics a physical asset transfer process for digital assets, such as eSIM profiles. Furthermore, the involvement of service providers in transactions between enterprises is minimal, creating a gap in control and security oversight. Thus, current techniques for transferring subscriber information, such as eSIM profiles, consume computing resources (e.g., processing resources, memory resources, communication resources, and/or the like), networking resources, and/or other resources associated with handling security issues associated with duplicating eSIM profiles, failing to transfer eSIM profiles between devices, identifying and preventing theft of eSIM profiles, failing to control transfers of eSIM profiles, and/or the like.

Some implementations described herein securely reuse a digital profile for a user equipment. For example, a device (e.g., a subscription server) may receive a request to transfer a digital profile from a first eSIM to a second eSIM, where the digital profile includes multiple seeds used to generate new network authentication keys. The subscription server may generate, based on one of the multiple seeds, the new network authentication keys for the digital profile, and may replace existing network authentication keys of the digital profile with the new network authentication keys. The subscription server may communicate the new network authentication keys to a mobile network operator backend system, and may enable the digital profile with the new network authentication keys on the second eSIM. The subscription server may prevent reuse of the digital profile on the first eSIM. In some implementations, the term “eSIM,” as used herein, may include all remote SIM provisioning technologies, such as an embedded SIM (eSIM), an integrated SIM (iSIM), an integrated universal integrated circuit card (IUICC), a soft SIM, and/or the like.

In this way, the subscription server may securely reuse a digital profile for a user equipment. For example, the subscription server may provide for secure and efficient transfer of digital eSIM profiles between UEs, while preventing digital profile cloning and managing digital assets effectively. The subscription server may generate new network authentication keys based on multiple seeds that are encrypted using diversified asymmetric keys managed by a mobile network operator. The subscription server may replace existing network authentication keys of the digital profile with the new network authentication keys, may prevent reuse of the digital profile on a first eSIM, and may enable the digital profile on a second eSIM. In some implementations, the subscription server may utilize a blockchain to store the digital profile via non-fungible tokens (NFTs). The subscription server may track usage of the multiple seeds and may prevent reuse of the multiple seeds for generating additional network authentication keys.

Thus, the subscription server may conserve computing resources, networking resources, and/or other resources that would have otherwise been consumed by handling security issues associated with duplicating eSIM profiles, failing to transfer eSIM profiles between devices, identifying and preventing theft of eSIM profiles, failing to control transfers of eSIM profiles, and/or the like. Furthermore, the subscription server may conserve computing resources, networking resources, and/or other resources by streamlining an authentication process, reducing a need for manual oversight in profile transfers, and by automating the tracking and management of digital profiles within a mobile network.

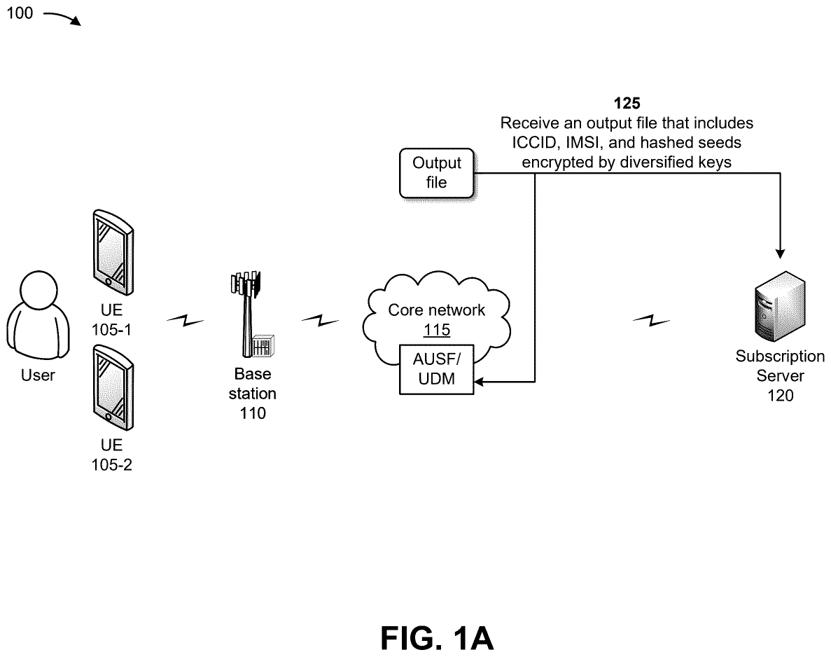

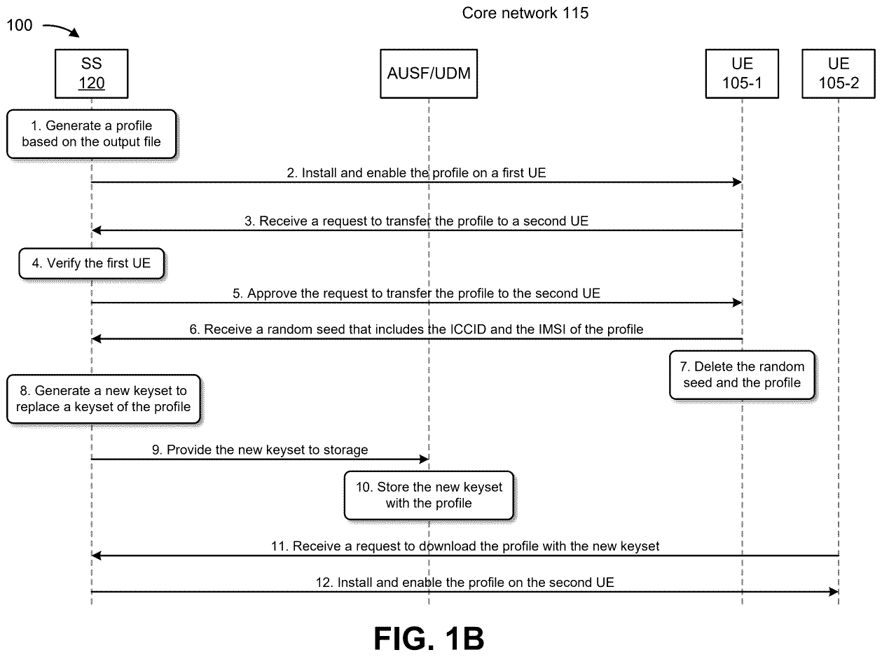

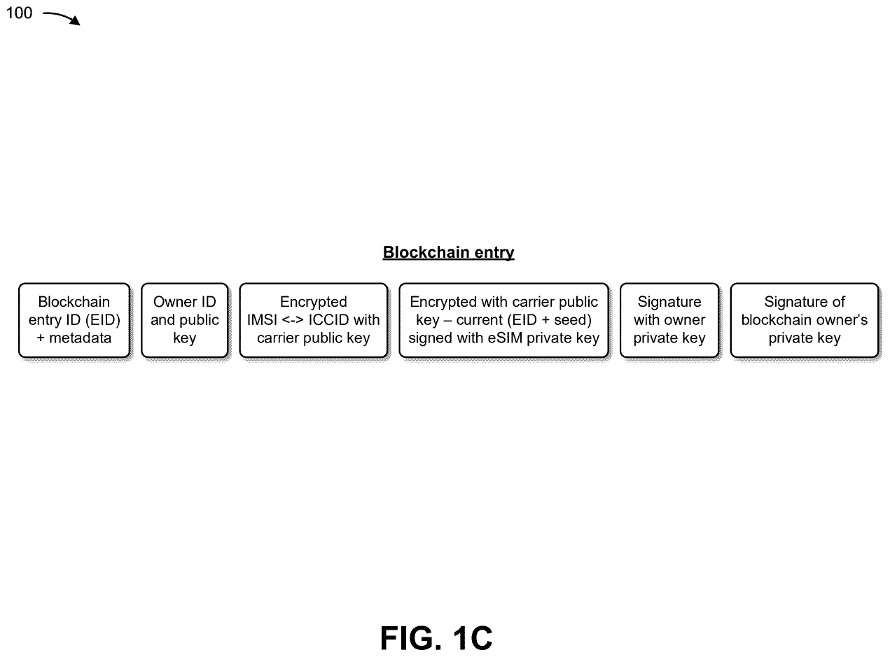

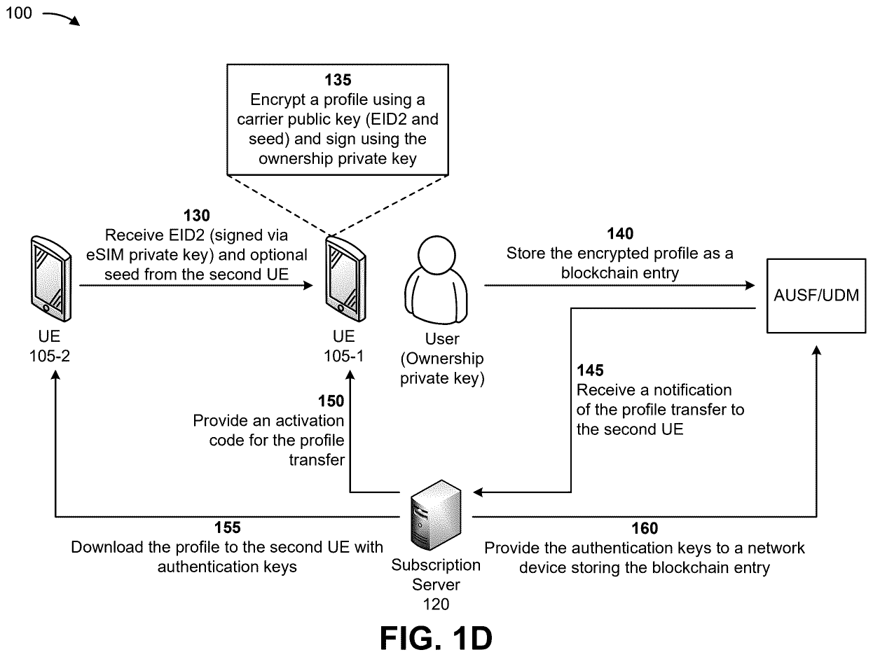

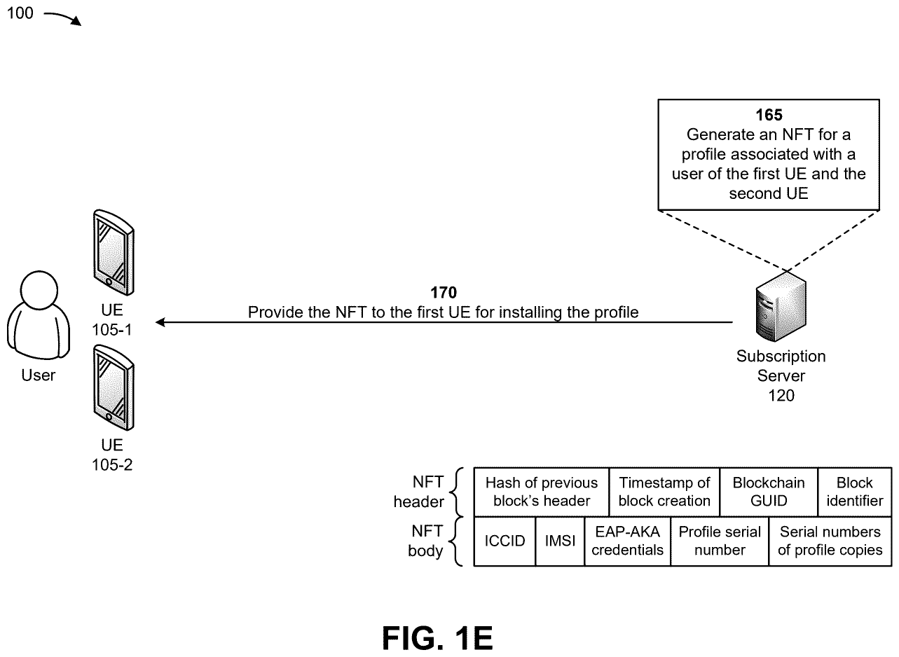

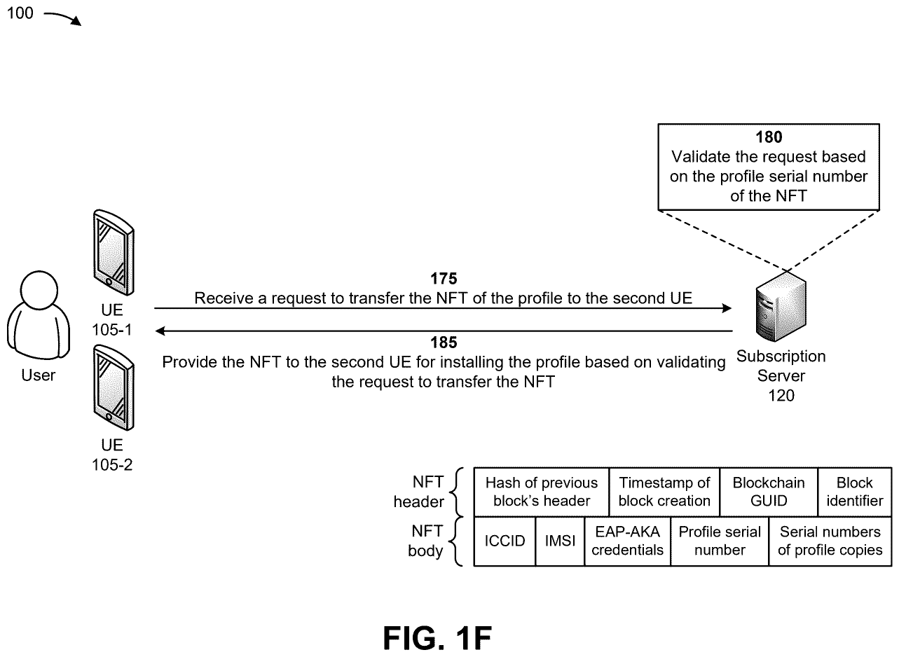

FIGS. 1A-1F are diagrams of an example 100 associated with securely reusing a digital profile for a user equipment. As shown in FIGS. 1A-1F, example 100 includes a first UE 105-1 and a second UE 105-2 associated with a user, a base station 110, a core network 115, and a subscription server 120. The core network 115 may include an authentication server function (AUSF) and a unified data management (UDM) component. In some implementations, the functions of the AUSF and the UDM component may be replaced by a home subscriber server (HSS) of the core network 115. Further details of the UEs 105, the base station 110, the core network 115, the AUSF, the UDM component, and the HSS are provided elsewhere herein.

As shown in FIG. 1A, and by reference number 125, the subscription server 120 may receive an output file that includes an integrated circuit card identifier (ICCID) of an eSIM provided in the first UE 105-1, an international mobile subscriber identity (IMSI) of the first UE 105-1, and hashed seeds encrypted by diversified keys. For example, a mobile network operator (MNO) may utilize a device to create an output file that includes input data for creating a digital profile. In some implementations, the output file may include the ICCID, the IMSI, and hashed seeds. The ICCID may include a unique identifier for the eSIM of the first UE 105-1, and the IMSI may include a unique identifier for a mobile subscriber (e.g., the user). The hashed seeds may be utilized to generate new network authentication keys, which may be encrypted by diversified asymmetric keys managed by the mobile network operator. Each hashed seed may be encrypted by a diversified key to ensure security. The MNO device may provide the output file to the subscription server 120 and backend systems of the mobile network operator (e.g., the HSS, the AUSF, and the UDM component). The subscription server 120 and the AUSF/UDM may receive the output file from the MNO device.

In some implementations, the subscription server 120 may utilize the output file to generate a digital profile based on the input data of the output file. The digital profile may be downloaded and enabled in the eSIM of the first UE 105-1. Upon receiving the digital profile, the first UE 105-1 may utilize the digital profile to connect to a network (e.g., the core network 115 via the base station 110).

FIG. 1B depicts an example information flow diagram associated with securely reusing a digital profile for a UE 105. As shown at step 1, the subscription server (SS) 120 may generate a profile (e.g., a digital profile associated with the user) based on the output file. For example, the subscription server 120 may utilize the output file, which includes input data such as the ICCID, the IMSI, and the hashed seeds encrypted by diversified keys, to create the digital profile. The subscription server 120 may prepare the digital profile for installation on a UE 105, such as the first UE 105-1. In some implementations, the subscription server 120 may retrieve a profile template based on the output file, and may utilize the profile template to generate the digital profile. The profile template may include predefined settings and parameters necessary for proper functioning of the digital profile.

For securing the seeds, the subscription server 120 may utilize an encryption mechanism based on diversified asymmetric keys. Each seed may first be encrypted using the mobile network operator's public key, ensuring that only the operator can decrypt the seeds using their private key. Additionally, each seed may be hashed and then encrypted again with a uniquely generated asymmetric key pair for each transaction. This double encryption process may ensure that even if one key is compromised, the seeds remain secure. The encrypted seeds may be stored in a secure database managed by the subscription server 120.

As shown at step 2, the subscription server 120 may install and enable the profile on a first UE 105-1 (e.g., on an eSIM associated with the first UE 105-1). For example, the subscription server 120 may download and activate the digital profile on the eSIM of the first UE 105-1, allowing the first UE 105-1 to connect to the core network 115 via the base station 110. Additionally, or alternatively, the subscription server 120 may configure the profile on the first UE 105-1. In such implementations, the subscription server 120 may adjust settings and properties of the profile to align with the requirements of the core network 115.

As shown at step 3, the subscription server 120 may receive a request to transfer the profile to the second UE 105-2 (e.g., to an eSIM associated with the second UE 105-2). For example, the user of the first UE 105-1 may cause the first UE 105-1 to generate the request to transfer the digital profile to the second UE 105-2. The first UE 105-1 may provide, to the subscription server 120, the request to transfer the digital profile, and the subscription server 120 may receive the request to transfer the digital profile. Additionally, or alternatively, the subscription server 120 may process the request to transfer the digital profile, while ensuring that all security protocols are satisfied.

As shown at step 4, the subscription server 120 may verify the first UE 105-1. For example, the subscription server 120 may authenticate the first UE 105-1 to request the transfer of the digital profile. The subscription server 120 may authenticate the first UE 105-1 by checking an identifier of the first UE 105-1, the IMSI of the first UE 105-1, and other relevant information to ensure that the request to transfer is legitimate. Additionally, or alternatively, the subscription server 120 may authenticate the first UE 105-1 by cross-referencing credentials of the first UE 105-1 with a database containing authorized UEs 105. If the subscription server 120 fails to authenticate the first UE 105-1, the subscription server 120 may deny the request to transfer the digital profile. In such implementations, the subscription server 120 may provide, to the first UE 105-1, a notification indicating the denial of the request to transfer the digital profile.

As shown at step 5, the subscription server 120 may approve the request to transfer the profile to the second UE 105-2. For example, if the subscription server authenticates the first UE 105-1 and verifies the legitimacy of the request, the subscription server 120 may grant permission for the transfer of the digital profile. The subscription server 120 may authorize the transfer of the digital profile to the second UE 105-2. The subscription server 120 may provide, to the first UE 105-1, a notification indicating the approval of the request to transfer the digital profile.

As shown at step 6, the subscription server 120 may receive a random seed that includes the ICCID and the IMSI of the profile. For example, the first UE 105-1 may send or otherwise provide a randomly selected hashed and encrypted seed, along with the ICCID and the IMSI, to the subscription server 120 as part of the transfer process. The subscription server 120 may utilize the random seed for generating new network authentication keys for the digital profile.

In one example implementation, the subscription server 120 may utilize a cryptographic model, such as the advanced encryption standard (AES), to generate new network authentication keys. The process begins with the subscription server 120 receiving the hashed and encrypted seeds from the first UE 105-1. The seeds may be decrypted using a private key managed by the mobile network operator. Once decrypted, the seeds may be hashed using a secure hash algorithm (e.g., SHA-256) to ensure data integrity and security. The resulting hash values may then be used as inputs to the AES model, which generates the new network authentication keys. The generated keys may include a subscriber authentication key (K), a Milenage key, a mobile network operator service domain key, and a secure copy protocol key. Each key may be associated with a specific function within the mobile network, ensuring secure communication and authentication. In some implementations, the subscription server 120 may replace the existing network authentication keys on the digital profile with the new keys by overwriting the old key values stored in the profile's metadata. The updated profile may then be encrypted using the mobile network operator's public key before being transmitted to the AUSF and/or the UDM component for storage.

As shown at step 7, the first UE 105-1 may delete the random seed and the profile from the first UE 105-1. As shown at step 7, after providing the random seed, the ICCID, and the IMSI to the subscription server 120, the first UE 105-1 may delete the random seed and the digital profile from the first UE 105-1. For example, the first UE 105-1 may erase the digital profile and the random seed to ensure that the digital profile and the random seed cannot be reused on the first UE 105-1. This may involve securely wiping the digital profile and the random seed from the eSIM of the first UE 105-1.

As shown at step 8, the subscription server 120 may generate a new keyset (e.g., new network authentication keys) to replace a keyset (e.g., existing network authentication keys) of the profile. For example, the subscription server 120 may use the random seed to generate the new network authentication keys for the digital profile. The new network authentication keys may replace the existing network authentication keys associated with the digital profile. The new network authentication keys may ensure continued secure communications with the network and for the digital profile.

As shown at step 9, the subscription server 120 may provide the new keyset (e.g., the new network authentication keys) to storage in the AUSF and/or the UDM component. For example, the subscription server 120 may provide the new network authentication keys to the AUSF and/or the UDM component for secure storage. This may ensure that the new network authentication keys are safely stored and retrievable for future use. In some implementations, the subscription server 120 may store the new network authentication keys in an HSS of the core network 115 (e.g., when the core network 115 is a fourth-generation (4G) core network).

As shown at step 10, the AUSF and/or the UDM component may store the new keyset with the profile. For example, the AUSF and/or the UDM component may update the stored digital profile with the new network authentication keys. Additionally, or alternatively, the AUSF and/or the UDM component may integrate the new keyset with the profile so that any future authentications will utilize the new network authentication keys. In some implementations, the HSS may store the digital profile and the new network authentication keys.

As shown at step 11, the subscription server 120 may receive a request to download the profile with the new keyset to the second UE 105-2. For example, the second UE 105-2 may generate the request to download the digital profile, and may provide the request to download the digital profile to the subscription server 120. The subscription server 120 may receive the request to download the digital profile from the second UE 105-2.

As shown at step 12, the subscription server 120 may install and enable the profile on the second UE 105-2. For example, the subscription server 120 may download and activate the digital profile on the eSIM of the second UE 105-2, allowing the second UE 105-2 to connect to the network with the new network authentication keys. Additionally, or alternatively, the subscription server 120 may deploy and activate the digital profile on the second UE 105-2. This may ensure that the digital profile is properly installed and operational on the second UE 105-2.

FIG. 1C depicts an example blockchain entry associated with a digital profile. The blockchain entry may be utilized to track ownership of and define a profile. The user or owner of the profile may be associated with a private/public key pair that enables the user to participate in a public or a private blockchain. As shown, the blockchain entry may include a blockchain entry identifier (EID) and metadata that may be utilized for maintaining a ledger. The blockchain entry may include an owner identifier (ID) and a public key that may be utilized to establish the owner of the profile. The blockchain entry may include an encrypted IMSI and ICCID pair that may be double encrypted. For example, the IMSI and ICCID pair may be encrypted with a carrier public key (e.g., to enable a carrier to decrypt the IMSI and the ICCID pair with a private key) and may be encrypted with the owner's public key so that the owner may see the IMSI and the ICCID pair with a private key. The IMSI and ICCID pair may be encrypted with the EID and a seed to enable the carrier to establish a current eSIM EID with a current profile. The blockchain entry may include a signature with the private key of the owner to ensure that the blockchain entry is created by the profile owner. The blockchain entry may include a signature of the blockchain owner's private key to ensure that there is an entity that authorizes entries into the blockchain.

As shown in FIG. 1D, and by reference number 130, the first UE 105-1 may receive a second EID (EID2) (e.g., signed via an eSIM private key) and an optional seed from the second UE 105-2. For example, the second UE 105-2 may sign the second EID with the eSIM private key (e.g., a cryptographic hash function), and may provide the signed second EID and the optional seed to the first UE 105-1. The first UE 105-1 may receive the signed second EID and the optional seed. This exchange may ensure that the digital profile can be securely transferred between the two UEs 105. In some implementations, the first UE 105-1 may receive a verification token along with the second EID and the optional seed from the second UE 105-2 for enhanced security. The verification token may be utilized by the first UE 105-1 to confirm the authenticity of the received second EID and the optional seed. Additionally, or alternatively, the second UE 105-2 may encrypt the second EID and a unique identifier using asymmetric encryption, and may provide the encrypted second EID and the encrypted unique identifier to the first UE 105-1. This may enhance privacy and security during data transmission.

As further shown in FIG. 1D, and by reference number 135, the first UE 105-1 may encrypt a profile using a carrier public key (e.g., the EID2 and the seed) and may sign the encrypted profile using the ownership private key. For example, the first UE 105-1 may utilize a carrier public key to encrypt the profile, which includes the EID2 and the seed, and may subsequently sign the encrypted profile with the ownership private key of the first UE 105-1. This may ensure that the profile is securely encrypted and authenticated by the first UE 105-1. In some implementations, the first UE 105-1 may additionally encrypt a timestamp along with the profile to ensure timeliness of the profile transfer. The timestamp may be utilized to verify a time at which the profile was encrypted. Additionally, or alternatively, the first UE 105-1 may utilize a hybrid encryption method (e.g., that combines symmetric encryption and asymmetric encryption) to encrypt the profile before signing the profile with the ownership private key. This may combine the fast encryption of symmetric methods with the secure key exchange of asymmetric methods. Additionally, or alternatively, the first UE 105-1 may encrypt the profile using a public key infrastructure (PKI) system to ensure robust security before signing the encrypted profile with the ownership private key.

As further shown in FIG. 1D, and by reference number 140, the first UE 105-1 may store the encrypted profile as a blockchain entry. For example, the first UE 105-1 may create a blockchain entry containing the encrypted profile and may store this entry within a blockchain system (e.g., provided by the AUSF and/or the UDM component). The blockchain entry may ensure the integrity and immutability of the stored profile. In some implementations, the first UE 105-1 may store the encrypted profile along with a digital certificate in the blockchain entry to enhance verification. The digital certificate may be used to authenticate an origin of the profile. Additionally, or alternatively, the blockchain entry may include metadata, such as a transaction identifier and a timestamp, to provide a detailed audit trail. This information may be utilized to track the history and timing of the blockchain entry. Additionally, or alternatively, the encrypted profile may be associated with a digital signature from a trusted third party to validate an authenticity of the encrypted profile within the blockchain. The digital certificate may provide an additional layer of trust and verification.

As further shown in FIG. 1D, and by reference number 145, the subscription server 120 may receive a notification of the profile transfer to the second UE 105-2. For example, once the profile is stored as a blockchain entry, the first UE 105-1 may notify the subscription server 120 about the profile transfer request to the second UE 105-2. This may ensure that the subscription server 120 is aware of the profile transfer and can manage the profile transfer. In some implementations, the subscription server 120 may also receive a confirmation of deletion of the profile from the first UE 105-1 to prevent reuse of the profile by the first UE 105-1. This may ensure that the profile is no longer available on the first UE 105-1 (e.g., and is not being utilized by more than one UE 105). Additionally, or alternatively, the notification of the profile transfer may include a transfer token to uniquely identify and track the profile transfer process.

As further shown in FIG. 1D, and by reference number 150, the subscription server 120 may provide an activation code for the profile transfer. For example, upon receiving the notification, the subscription server 120 may generate and send an activation code (e.g., a QR code, a numeric code, an alphabetical code, an alphanumeric code, and/or the like) to the first UE 105-1 to facilitate the transfer of the profile to the second UE 105-2. The activation code may be utilized by the user to download and activate the profile on the second UE 105-2. In some implementations, the activation code may be associated with an expiry timestamp to enhance security and prevent misuse of the profile. The expiry timestamp may ensure that the activation code cannot be used after a certain time period. Additionally, or alternatively, the subscription server 120 may include a verification hash with the activation code to ensure an integrity of the activation code. The verification hash may be utilized to verify that the activation code has not been tampered with. Additionally, or alternatively, the subscription server 120 may generate the activation code using a one-time password to further secure the transfer process.

As further shown in FIG. 1D, and by reference number 155, the subscription server 120 may download the profile to the second UE 105-2 with authentication keys (e.g., new network authentication keys). For example, the subscription server 120 may provide the profile, along with the new network authentication keys, to the second UE 105-2. This may ensure that the second UE 105-2 can securely utilize the profile with the new network authentication keys. In some implementations, the subscription server 120 may provide a secure token with the profile to authenticate the second UE 105-2. The token may be used to verify the identity of the second UE 105-2. Additionally, or alternatively, the subscription server 120 may provide a digital certificate with the profile to verify the authenticity of the profile. The digital certificate may serve as proof that the profile is genuine. Additionally, or alternatively, the subscription server 120 may generate the new network authentication keys using a secure key exchange protocol to ensure the integrity of the new network authentication keys.

As further shown in FIG. 1D, and by reference number 160, the subscription server 120 may provide the authentication keys to a network device storing the blockchain entry. For example, the subscription server 120 may provide the new network authentication keys to a network device, such as the AUSF and/or UDM component, that manages the blockchain entry. This may ensure that the network device has the necessary keys to authenticate and manage the profile in the blockchain system. In some implementations, the subscription server 120 may provide, to the network device, a notification instructing the network device to update records with the new network authentication keys. Additionally, or alternatively, the network device may validate the new network authentication keys against a trusted key management system before storing the keys. Additionally, or alternatively, the subscription server 120 may utilize a secure transmission protocol to provide the new network authentication keys to the network device, ensuring the confidentiality and integrity of the new network authentication keys.

As shown in FIG. 1E, and by reference number 165, the subscription server 120 may generate an NFT for a profile associated with a user of the first UE 105-1 and the second UE 105-2. For example, the subscription server 120 may create a blockchain entry that includes profile information, such as the ICCID, the IMSI, and extensible authentication protocol-authentication and key agreement (EAP-AKA) credentials, and may associate the blockchain entry with a unique profile serial number and metadata used for tracking the profile as a digital asset. In some implementations, the subscription server 120 may generate the NFT for the profile, and may provide the NFT in the blockchain entry. The NFT may include a digital identifier that represents ownership of the profile. In some implementations, the blockchain entry may also include serial numbers of authorized copies of the profile, a hash of a previous block's header, a timestamp of block creation, a blockchain globally unique identifier (GUID), and a block identifier to maintain the integrity and immutability of the profile information.

As further shown in FIG. 1E, and by reference number 170, the subscription server 120 may provide the NFT to the first UE 105-1 for installing the profile. For example, the subscription server 120 may transmit the NFT to the first UE 105-1, and the user may utilize the NFT to install the profile on the eSIM of the first UE 105-1. The first UE 105-1 may utilize the NFT to download and activate the profile, which may ensure secure and authenticated access to network services for the profile and the first UE 105-1. In some implementations, the NFT may be stored in a digital wallet on the first UE 105-1, which may enable the user to manage and transfer the profile securely between UEs 105.

As shown in FIG. 1F, and by reference number 175, the subscription server 120 may receive a request to transfer the NFT of the profile to the second UE 105-2. For example, the user may cause the first UE 105-1 to generate the request to transfer the NFT of the profile to the second UE 105-2, and to provide the request to the subscription server 120. The subscription server 120 may receive the request to transfer the NFT and may begin the transfer process by validating and processing the request. In some implementations, the request may include a request to transfer the NFT and the digital profile from the eSIM in the first UE 105-1 to the eSIM in the second UE 105-2. The request to transfer the NFT may ensure that the digital profile is securely and reliably moved from the eSIM of the first UE 105-1 to the eSIM of the second UE 105-2.

As further shown in FIG. 1F, and by reference number 180, the subscription server 120 may validate the request based on the profile serial number of the NFT. For example, the subscription server 120 may analyze the profile serial number associated with the NFT to ensure that the request to transfer is legitimate and that the profile can be securely transferred to the second UE 105-2. The subscription server 120 may cross-reference the profile serial number with records stored in a blockchain or another secure database. If the profile serial number matches one of the records, the subscription server 120 may validate the request to transfer. Alternatively, if the profile serial number fails to match one of the records, the subscription server 120 may deny the request to transfer the NFT to the second UE 105-2.

In some implementations, the subscription server 120 may verify the authenticity of the transfer request by checking an encrypted seed associated with the digital profile. This verification may include the subscription server 120 decrypting the seed to ensure its validity before transferring the profile. Additionally, or alternatively, the subscription server 120 may validate the transfer request by comparing a hashed seed with stored records. Additionally, or alternatively, the subscription server 120 may validate the transfer request using blockchain technology. A blockchain verification may ensure that the transfer request has not been tampered with and is part of a secure and immutable record.

As further shown in FIG. 1F, and by reference number 185, the subscription server 120 may provide the NFT to the second UE 105-2 for installing the profile based on validating the request to transfer the NFT. For example, when the subscription server 120 validates the request to transfer, the subscription server 120 may transmit the NFT to the second UE 105-2. The NFT may enable the second UE 105-2 to install and activate the profile on the eSIM of the second UE 105-2. This may ensure a secure and authenticated profile transfer between the UEs 105, while maintaining the integrity and security of the digital profile. In some implementations, the subscription server 120 may provide the profile and the new network authentication keys to the second UE 105-2. This may ensure that the profile has the latest network authentication keys necessary for secure operation on the second UE 105-2. Additionally, or alternatively, when the subscription server 120 validates the request to transfer, the subscription server 120 may generate new network authentication keys and may provide the profile to the second UE 105-2. The generation of the new network authentication keys may prevent any misuse of old keys and may secure the profile transition.

In some implementations, the subscription server 120 may set a profile re-downloading counter to verify and approve subsequent re-downloads of the digital profile until a predefined value is satisfied. For example, each time the digital profile is downloaded to a new eSIM, the counter may be decremented. Once the counter reaches zero, further re-downloads of the same profile may be denied, ensuring controlled and secure reuse of the digital profile.

In this way, the subscription server 120 may securely reuse a digital profile for a UE 105. For example, the subscription server 120 may provide for secure and efficient transfer of digital eSIM profiles between UEs 105, while preventing digital profile cloning and managing digital assets effectively. The subscription server 120 may generate new network authentication keys based on multiple seeds that are encrypted using diversified asymmetric keys managed by a mobile network operator. The subscription server 120 may replace existing network authentication keys of the digital profile with the new network authentication keys, may prevent reuse of the digital profile on a first eSIM, and may enable the digital profile on a second eSIM. In some implementations, the subscription server 120 may utilize a blockchain to store the digital profile via NFTs. The subscription server 120 may track usage of the multiple seeds and may prevent reuse of the multiple seeds for generating additional network authentication keys.

Thus, the subscription server 120 may conserve computing resources, networking resources, and/or other resources that would have otherwise been consumed by handling security issues associated with duplicating eSIM profiles, failing to transfer eSIM profiles between devices, identifying and preventing theft of eSIM profiles, failing to control transfers of eSIM profiles, and/or the like. Furthermore, the subscription server 120 may conserve computing resources, networking resources, and/or other resources by streamlining an authentication process, reducing a need for manual oversight in profile transfers, and by automating the tracking and management of digital profiles within a mobile network.

As indicated above, FIGS. 1A-1F are provided as an example. Other examples may differ from what is described with regard to FIGS. 1A-1F. The number and arrangement of devices shown in FIGS. 1A-1F are provided as an example. In practice, there may be additional devices, fewer devices, different devices, or differently arranged devices than those shown in FIGS. 1A-1F. Furthermore, two or more devices shown in FIGS. 1A-1F may be implemented within a single device, or a single device shown in FIGS. 1A-1F may be implemented as multiple, distributed devices. Additionally, or alternatively, a set of devices (e.g., one or more devices) shown in FIGS. 1A-1F may perform one or more functions described as being performed by another set of devices shown in FIGS. 1A-1F.

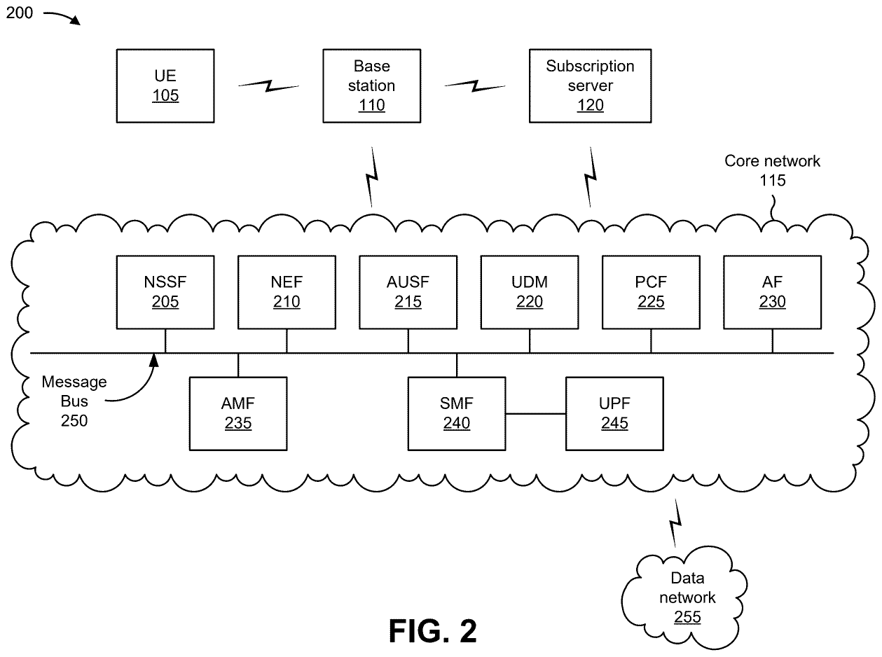

FIG. 2 is a diagram of an example environment 200 in which systems and/or methods described herein may be implemented. As shown in FIG. 2, the example environment 200 may include the UE 105, the base station 110, the core network 115, and a data network 255. Devices and/or networks of the example environment 200 may interconnect via wired connections, wireless connections, or a combination of wired and wireless connections.

The UE 105 includes one or more devices capable of receiving, generating, storing, processing, and/or providing information, such as information described herein. For example, the UE 105 may include a mobile phone (e.g., a smart phone or a radiotelephone), a laptop computer, a tablet computer, a desktop computer, a handheld computer, a gaming device, a wearable communication device (e.g., a smart watch or a pair of smart glasses), a mobile hotspot device, a fixed wireless access device, customer premises equipment, an autonomous vehicle, or a similar type of device.

The base station 110 may support, for example, a cellular radio access technology (RAT). The base station 110 may include one or more base stations (e.g., base transceiver stations, radio base stations, node Bs, eNodeBs (eNBs), gNodeBs (gNBs), base station subsystems, cellular sites, cellular towers, access points, transmit receive points (TRPs), radio access nodes, macrocell base stations, microcell base stations, picocell base stations, femtocell base stations, or similar types of devices) and other network entities that can support wireless communication for the UE 105. The base station 110 may transfer traffic between the UE 105 (e.g., using a cellular RAT), one or more base stations (e.g., using a wireless interface or a backhaul interface, such as a wired backhaul interface), and/or the core network 115. The base station 110 may provide one or more cells that cover geographic areas.

In some implementations, the base station 110 may perform scheduling and/or resource management for the UE 105 covered by the base station 110 (e.g., the UE 105 covered by a cell provided by the base station 110). In some implementations, the base station 110 may be controlled or coordinated by a network controller, which may perform load balancing, network-level configuration, and/or other operations. The network controller may communicate with the base station 110 via a wireless or wireline backhaul. In some implementations, the base station 110 may include a network controller, a self-organizing network (SON) module or component, or a similar module or component. In other words, the base station 110 may perform network control, scheduling, and/or network management functions (e.g., for uplink, downlink, and/or sidelink communications of the UE 105 covered by the base station 110).

In some implementations, the core network 115 may include an example functional architecture in which systems and/or methods described herein may be implemented. For example, the core network 115 may include an example architecture of a fifth generation (5G) next generation (NG) core network included in a 5G wireless telecommunications system. While the example architecture of the core network 115 shown in FIG. 2 may be an example of a service-based architecture, in some implementations, the core network 115 may be implemented as a reference-point architecture and/or a 4G core network, among other examples.

As shown in FIG. 2, the core network 115 may include a number of functional elements. The functional elements may include, for example, a network slice selection function (NSSF) 205, a network exposure function (NEF) 210, an AUSF 215, a UDM component 220, a policy control function (PCF) 225, an application function (AF) 230, an access and mobility management function (AMF) 235, a session management function (SMF) 240, and/or a user plane function (UPF) 245. These functional elements may be communicatively connected via a message bus 250. Each of the functional elements shown in FIG. 2 is implemented on one or more devices associated with a wireless telecommunications system. In some implementations, one or more of the functional elements may be implemented on physical devices, such as an access point, a base station, and/or a gateway. In some implementations, one or more of the functional elements may be implemented on a computing device of a cloud computing environment.

The NSSF 205 includes one or more devices that select network slice instances for the UE 105. By providing network slicing, the NSSF 205 allows an operator to deploy multiple substantially independent end-to-end networks potentially with the same infrastructure. In some implementations, each slice may be customized for different services.

The NEF 210 includes one or more devices that support exposure of capabilities and/or events in the wireless telecommunications system to help other entities in the wireless telecommunications system discover network services.

The AUSF 215 includes one or more devices that act as an authentication server and support the process of authenticating the UE 105 in the wireless telecommunications system.

The UDM 220 includes one or more devices that store user data and profiles in the wireless telecommunications system. The UDM 220 may be used for fixed access and/or mobile access in the core network 115.

The PCF 225 includes one or more devices that provide a policy framework that incorporates network slicing, roaming, packet processing, and/or mobility management, among other examples.

The AF 230 includes one or more devices that support application influence on traffic routing, access to the NEF 210, and/or policy control, among other examples.

The AMF 235 includes one or more devices that act as a termination point for non-access stratum (NAS) signaling and/or mobility management, among other examples.

The SMF 240 includes one or more devices that support the establishment, modification, and release of communication sessions in the wireless telecommunications system. For example, the SMF 240 may configure traffic steering policies at the UPF 245 and/or may enforce user equipment Internet protocol (IP) address allocation and policies, among other examples.

The UPF 245 includes one or more devices that serve as an anchor point for intraRAT and/or interRAT mobility. The UPF 245 may apply rules to packets, such as rules pertaining to packet routing, traffic reporting, and/or handling user plane quality of service (QoS), among other examples.

The message bus 250 represents a communication structure for communication among the functional elements. In other words, the message bus 250 may permit communication between two or more functional elements.

The data network 255 includes one or more wired and/or wireless data networks. For example, the data network 255 may include an IP Multimedia Subsystem (IMS), a public land mobile network (PLMN), a local area network (LAN), a wide area network (WAN), a metropolitan area network (MAN), a private network such as a corporate intranet, an ad hoc network, the Internet, a fiber optic-based network, a cloud computing network, a third party services network, an operator services network, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the example environment 200 may perform one or more functions described as being performed by another set of devices of the example environment 200.

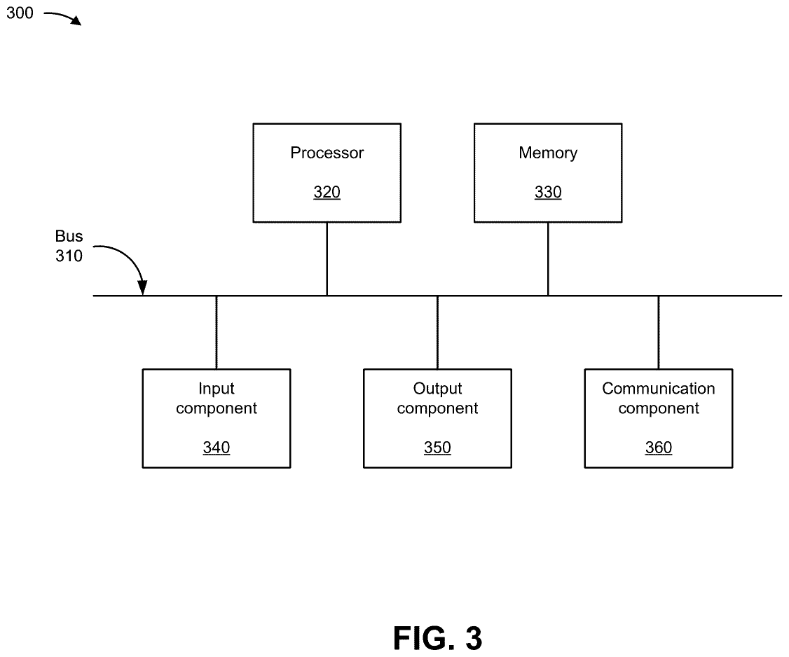

FIG. 3 is a diagram of example components of a device 300, which may correspond to the UE 105, the base station 110, the subscription server 120, the NSSF 205, the NEF 210, the AUSF 215, the UDM 220, the PCF 225, the AF 230, the AMF 235, the SMF 240, and/or the UPF 245. In some implementations, the UE 105, the base station 110, the subscription server 120, the NSSF 205, the NEF 210, the AUSF 215, the UDM 220, the PCF 225, the AF 230, the AMF 235, the SMF 240, and/or the UPF 245 may include one or more devices 300 and/or one or more components of the device 300. As shown in FIG. 3, the device 300 may include a bus 310, a processor 320, a memory 330, an input component 340, an output component 350, and a communication component 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit, a graphics processing unit, a microprocessor, a controller, a microcontroller, a digital signal processor, a field-programmable gate array, an application-specific integrated circuit, and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

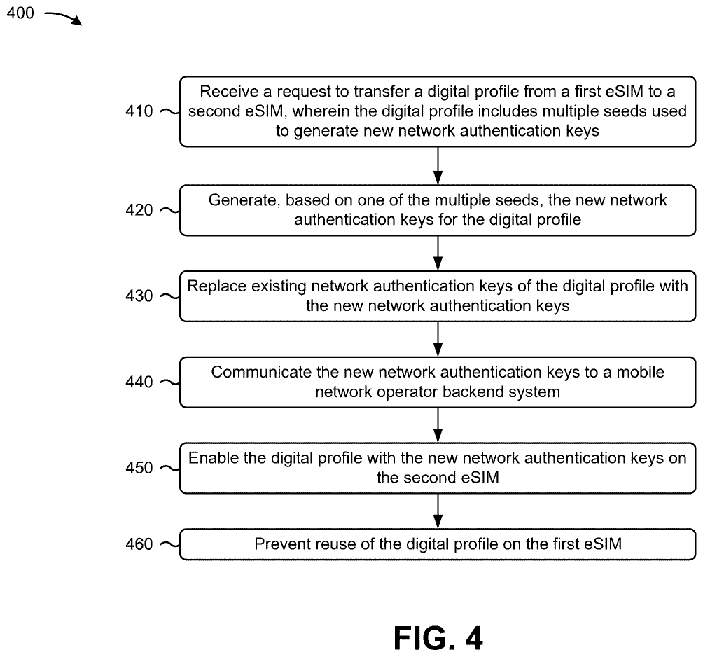

FIG. 4 is a flowchart of an example process 400 for securely reusing a digital profile for a user equipment. In some implementations, one or more process blocks of FIG. 4 may be performed by a device, such as a subscription server (e.g., the subscription server 120). In some implementations, one or more process blocks of FIG. 4 may be performed by another device or a group of devices separate from or including the device, such as a network device of the core network 115 (e.g., the AUSF 215 and/or the UDM 220). Additionally, or alternatively, one or more process blocks of FIG. 4 may be performed by one or more components of the device 300, such as the processor 320, the memory 330, the input component 340, the output component 350, and/or the communication component 360.

As shown in FIG. 4, process 400 may include receiving a request to transfer a digital profile from a first eSIM to a second eSIM, wherein the digital profile includes multiple seeds used to generate new network authentication keys (block 410). For example, the device may receive a request to transfer a digital profile from a first eSIM to a second eSIM, wherein the digital profile includes multiple seeds used to generate new network authentication keys, as described above. In some implementations, the request to transfer the digital profile includes a hashed seed and an encrypted seed randomly selected from the multiple seeds. In some implementations, the digital profile includes IMSI and ICCID information. In some implementations, the new network authentication keys include one or more of a subscriber authentication key, a Milenage key, a mobile network operator service domain key, or a secure copy protocol key. In some implementations, the first eSIM is provided in a first UE and the second eSIM is provided in a second UE.

As further shown in FIG. 4, process 400 may include generating, based on one of the multiple seeds, the new network authentication keys for the digital profile (block 420). For example, the device may generate, based on one of the multiple seeds, the new network authentication keys for the digital profile, as described above.

As further shown in FIG. 4, process 400 may include replacing existing network authentication keys of the digital profile with the new network authentication keys (block 430). For example, the device may replace existing network authentication keys of the digital profile with the new network authentication keys, as described above.

As further shown in FIG. 4, process 400 may include communicating the new network authentication keys to a mobile network operator backend system (block 440). For example, the device may communicate the new network authentication keys to a mobile network operator backend system, as described above. In some implementations, the mobile network operator backend system includes one of an HSS, an AUSF, or a UDM component.

As further shown in FIG. 4, process 400 may include enabling the digital profile with the new network authentication keys on the second eSIM (block 450). For example, the device may enable the digital profile with the new network authentication keys on the second eSIM, as described above.

As further shown in FIG. 4, process 400 may include preventing reuse of the digital profile on the first eSIM (block 460). For example, the device may prevent reuse of the digital profile on the first eSIM, as described above.

In some implementations, process 400 includes encrypting the multiple seeds using diversified asymmetric keys managed by a mobile network operator. In some implementations, process 400 includes storing the digital profile with the new network authentication keys in a blockchain. In some implementations, the blockchain stores the digital profile via non-fungible tokens. In some implementations, process 400 includes receiving a notification from the first eSIM indicating that the digital profile has been deleted from the first eSIM.

In some implementations, process 400 includes setting a digital profile re-downloading counter to verify and approve subsequent re-downloads of the digital profile until a predefined value is satisfied. In some implementations, process 400 includes managing the digital profile as a digital asset using blockchain technology to track ownership and define transfers of the digital profile. In some implementations, process 400 includes tracking usage of the multiple seeds, and preventing reuse of the multiple seeds to generate additional network authentication keys.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device, a request to transfer a digital profile from a first electronic subscriber identity module (eSIM) to a second eSIM, wherein the digital profile includes multiple seeds used to generate new network authentication keys;
generating, by the device and based on one of the multiple seeds, the new network authentication keys for the digital profile;
replacing, by the device, existing network authentication keys of the digital profile with the new network authentication keys;
communicating, by the device, the new network authentication keys to a mobile network operator backend system;
enabling, by the device, the digital profile with the new network authentication keys on the second eSIM; and
preventing, by the device, reuse of the digital profile on the first eSIM.

2. The method of claim 1, further comprising:
encrypting the multiple seeds using diversified asymmetric keys managed by a mobile network operator.

3. The method of claim 1, wherein the request to transfer the digital profile includes a hashed seed and an encrypted seed randomly selected from the multiple seeds.

4. The method of claim 1, further comprising:
storing the digital profile with the new network authentication keys in a blockchain.

5. The method of claim 4, wherein the blockchain stores the digital profile via non-fungible tokens.

6. The method of claim 1, wherein the digital profile includes international mobile subscriber identity and integrated circuit card identifier information.

7. The method of claim 1, further comprising:
receiving a notification from the first eSIM indicating that the digital profile has been deleted from the first eSIM.

8. A device, comprising:
one or more processors configured to:
receive a request to transfer a digital profile from a first electronic subscriber identity module (eSIM) to a second eSIM, wherein the digital profile includes multiple seeds used to generate new network authentication keys and the digital profile includes international mobile subscriber identity and integrated circuit card identifier information;
generate, based on one of the multiple seeds, the new network authentication keys for the digital profile;
replace existing network authentication keys of the digital profile with the new network authentication keys;
communicate the new network authentication keys to a mobile network operator backend system;
enable the digital profile with the new network authentication keys on the second eSIM; and
prevent reuse of the digital profile on the first eSIM.

9. The device of claim 8, wherein the mobile network operator backend system includes one of a home subscriber server, an authentication server function, or a unified data management component.

10. The device of claim 8, wherein the new network authentication keys include one or more of a subscriber authentication key, a Milenage key, a mobile network operator service domain key, or a secure copy protocol key.

11. The device of claim 8, wherein the one or more processors are further configured to:
set a digital profile re-downloading counter to verify and approve subsequent re-downloads of the digital profile until a predefined value is satisfied.

12. The device of claim 8, wherein the one or more processors are further configured to:
manage the digital profile as a digital asset using blockchain technology to track ownership and define transfers of the digital profile.

13. The device of claim 8, wherein the first eSIM is provided in a first user equipment (UE) and the second eSIM is provided in a second UE.

14. The device of claim 8, wherein the one or more processors are further configured to:
track usage of the multiple seeds; and
prevent reuse of the multiple seeds to generate additional network authentication keys.

15. A non-transitory computer-readable medium storing a set of instructions, the set of instructions comprising:
one or more instructions that, when executed by one or more processors of a device, cause the device to:
receive a request to transfer a digital profile from a first electronic subscriber identity module (eSIM) to a second eSIM, wherein the digital profile includes multiple seeds used to generate new network authentication keys,
wherein the request to transfer the digital profile includes a hashed seed and an encrypted seed randomly selected from the multiple seeds;
generate, based on one of the multiple seeds, the new network authentication keys for the digital profile;
replace existing network authentication keys of the digital profile with the new network authentication keys;
communicate the new network authentication keys to a mobile network operator backend system;
enable the digital profile with the new network authentication keys on the second eSIM; and
prevent reuse of the digital profile on the first eSIM.

16. The non-transitory computer-readable medium of claim 15, wherein the one or more instructions further cause the device to:
encrypt the multiple seeds using diversified asymmetric keys managed by a mobile network operator.

17. The non-transitory computer-readable medium of claim 15, wherein the one or more instructions further cause the device to:
store the digital profile with the new network authentication keys in a blockchain,
wherein the blockchain stores the digital profile via non-fungible tokens.

18. The non-transitory computer-readable medium of claim 15, wherein the one or more instructions further cause the device to:
receive a notification from the first eSIM indicating that the digital profile has been deleted from the first eSIM.

19. The non-transitory computer-readable medium of claim 15, wherein the one or
more instructions further cause the device to:
set a digital profile re-downloading counter to verify and approve subsequent re-downloads of the digital profile until a predefined value is satisfied.

20. The non-transitory computer-readable medium of claim 15, wherein the one or more instructions further cause the device to:
track usage of the multiple seeds; and
prevent reuse of the multiple seeds to generate additional network authentication keys.
